(19) United States
(12) Patent Application Publication
(10) Pub. No.: US 2016/0086372 A1
(43) Pub. Date: Mar. 24, 2016

(54) Three Dimensional Targeting Structure for Augmented Reality Applications

(71) Applicant: Huntington Ingalls Incorporated, Newport News, VA (US)

(72) Inventors: David M. Trull, Newport News, VA (US); Durrell R. Blanks, Newport News, VA (US); Mary C. Mclaughlin, Newport News, VA (US)

(21) Appl. No.: 14/860,948

(22) Filed: Sep. 22, 2015

Related U.S. Application Data
(60) Provisional application No. 62/053,293, filed on Sep. 22, 2014.

(51) Int. Cl. G06T 15/10; G02B 27/01; G06T 3/40; H04N 7/18; G06T 19/00; G06T 7/00

(52) U.S. Cl. CPC G06T 15/10; G06T 19/006; G06T 7/004; G06T 3/40; H04N 7/18; G02B 27/0101; G06T 2219/2016; G06T 2207/30244; G02B 2027/0138; G02B 2027/014

(57) ABSTRACT

A method is provided for obtaining AR information for display on a mobile interface device. The method comprises placing a three dimensional targeting structure in a target space, the targeting structure comprising a plurality of planar, polygonal facets each having a unique target pattern applied thereto. A position of the targeting structure relative to the target space is then determined. The method further comprises capturing an image of a portion of the target space including the targeting structure and identifying the unique target pattern of one of the plurality facets visible in the captured image. The method also comprises establishing a pose of the mobile interface device relative to the target space using the captured image and the position of the targeting structure, obtaining AR information associated with the unique target pattern of the particular one of the plurality facets, and displaying the AR information on the mobile interface device.

### CROSS-REFERENCE TO RELATED APPLICATIONS

This application claims priority to U.S. Provisional Application No. 62/053,293, filed Sep. 22, 2014, the complete disclosure of which is incorporated herein by reference in its entirety.

### FIELD OF THE INVENTION

The present invention relates generally to the field of targeting for augmented reality and more particularly to portable three dimensional targeting structures and methods of using such structures to provide augmented reality information.

### BACKGROUND OF THE INVENTION

Augmented reality (AR) provides a view of a physical, real-world environment whose elements are augmented (or supplemented) by computer-generated sensory input such as sound, text, graphics, or video. Augmented reality is useful in various applications including construction, repair, maintenance, education, navigation, design, military, medical, or entertainment, for example. In various applications, AR can be used to provide information associated with particular objects or spaces that can be used to conduct maintenance, construction or other operations. It is particularly useful when such information includes spatially oriented images or other information that can be viewed over real time captured images of an object or space.

Such applications require that the position (x,y,z) and angular orientation (θ,φ,ζ) (collectively referred to herein as the “pose”) of the device displaying the AR information be known. This can be accomplished using an external positioning system and a spatial coordinate system such as are discussed in more detail in U.S. application Ser. No. 14/210,601, filed Mar. 14, 2014 (the “'601 Application”), the complete disclosure of which is incorporated herein by reference in its entirety.

Pose can also be established through the recognition of an image target or marker in an image captured by the device. The ability to recognize and track image targets enables the positioning and orientation of virtual objects, such as 3D models and other media, in relation to real world images without the use of an external positioning system. The displaying device sues the target image to establish its pose which allows the positioning and orientation of an AR image in real-time so that the viewer's perspective on the object corresponds with their perspective on the image target. Thus, the virtual object appears to be a part of the real world scene.

A typical AR application generally uses one or more planar image targets which are fixed in a horizontal or vertical plane giving the viewer at most single or bi-directional targeting. This naturally limits the number of degrees of freedom available to the targeting device due to the inability to accurately identify targets that are substantially spatially separated or in opposing planes relative to each other. When multiple targets are substantially separated spatially or in planes requiring a user to pan by moving the angle of the interface device such that one or more targets goes out of view, the user of an interface device, mobile or fixed, may pan from one target, to no target, to a second target. Augmentation in this configuration runs the risk of disappearing or of losing pose between the field of view (FOV) of one target and the FOV of the next target.

This potential loss of visualization or dead space exists when the user encounters a location or angle in which target recognition is not possible as it goes out of view or becomes distorted at best. At extreme angles relative to single plane targets, it becomes increasingly difficult to identify and read the target pattern and render an accurate augmentation of the space or object being viewed.

### SUMMARY OF THE INVENTION

An aspect of the present invention provides a method for obtaining AR information for display on a mobile interface device. The method comprises placing a three dimensional targeting structure in a target space. The targeting structure has an outer surface comprising a plurality of planar, polygonal facets, each facet having a different angular orientation and having a unique target pattern applied thereto. The method further comprises determining a position of the targeting structure relative to a fixed reference point in the target space. The method still further comprises capturing with the mobile interface device an image of a portion of the target space including the targeting structure. The method also comprises identifying the unique target pattern of a particular one of the plurality facets visible in the captured image, establishing a pose of the mobile interface device relative to the target space using the captured image and the position of the targeting structure, and obtaining AR information associated with the unique target pattern of the particular one of the plurality facets. Once obtained, the AR information is displayed on the mobile interface device.

### BRIEF DESCRIPTION OF THE DRAWINGS

The present invention may be better understood by reading the following detailed description together with the accompanying drawings, in which

FIG. 1 is a perspective view of a cubic targeting structure according to an embodiment of the invention;

FIG. 2 is a perspective view of a high density, multi-faceted targeting structure according to an embodiment of the invention;

FIG. 3 is a perspective view of targeting structure of FIG. 2 with targeting patterns applied to the planar facets thereof in accordance with an embodiment of the invention;

FIG. 4 is a perspective view of a-targeting structure formed as a dodecahedron (12 pentagons) with targeting patterns applied to each planar pentagonal facet in accordance with an embodiment of the invention;

FIG. 5 is a perspective view of a targeting structure according to an embodiment of the invention;

FIG. 6 is a perspective view of a targeting structure according to an embodiment of the invention in which the structure has an inner supporting structure;

FIG. 7 depicts a section of a modular targeting structure according to an embodiment of the invention;

FIG. 8 is a schematic representation of a system for providing AR information according to an embodiment of the invention;

FIG. 9 is a block diagram of a method of obtaining AR information for display on a mobile interface device;

FIG. 10 is a perspective view of target space in which a targeting structure has been disposed; and

FIG. 11 is a depiction of a mobile interface device in which a user is entering relative positional data for a targeting structure.

### DETAILED DESCRIPTION OF THE INVENTION

As noted above, typical AR targets present the problem of loss of visualization at particular locations/orientations relative to the target. There are some relative positions where target recognition is not possible because the target view is distorted or because the target is not even in view. At extreme angles relative to single plane targets, it becomes increasingly difficult to identify and read the target pattern and render an accurate augmentation of the space or object being viewed.

Some embodiments of the present invention provide a solution to this problem by providing three dimensional targets with multiple targeting surfaces having a fixed spatial relationship. Using these targets and multi-target AR software techniques such as those described by Qualcomm Incorporated in conjunction with its VUFORIA® product allows the elimination of dead spots and other problems associated with planar targets. With multi-targets, once one part of a multi-target is detected, all other parts can be tracked since their relative position and orientation is known.

The present invention significantly expands the degrees of freedom available for targeting by providing a robust, high density, multi-planar structure that will allow nearly unlimited line of sight targeting, thereby providing the viewer with nearly unlimited localization relative to the targeting structure. The targeting structure comprises a number of geometrically shaped targeting surfaces, where each targeting surface comprises one or more targets, arranged to form a three dimensional polygon (polyhedron) configuration that locates and orients the targets in three dimensions each in a fixed relationship relative to a central point. The targeting surfaces are assembled in an edge to edge arrangement in a fixed relationship relative to each other forming a three-dimensional polygon. The angles of the targeting surfaces relative to each other may be optimized to minimize loss of tracking that generally occurs at the edges and to maximize the structure's ability to provide continuous tracking Each target is unique and configured in the structure such that a viewer will be able to have a direct line of sight to one or more targets from any location relative to the targeting structure.

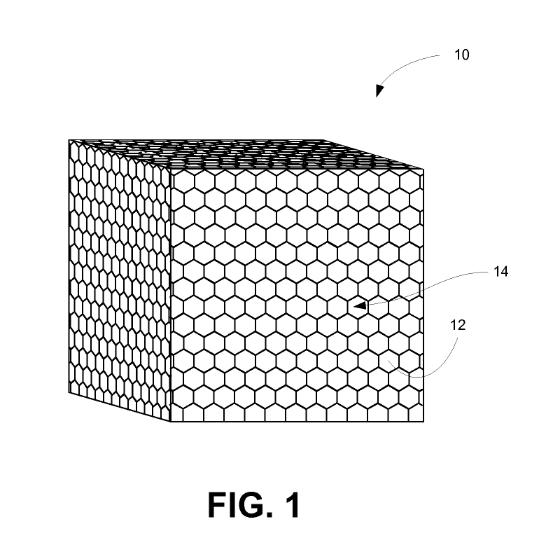

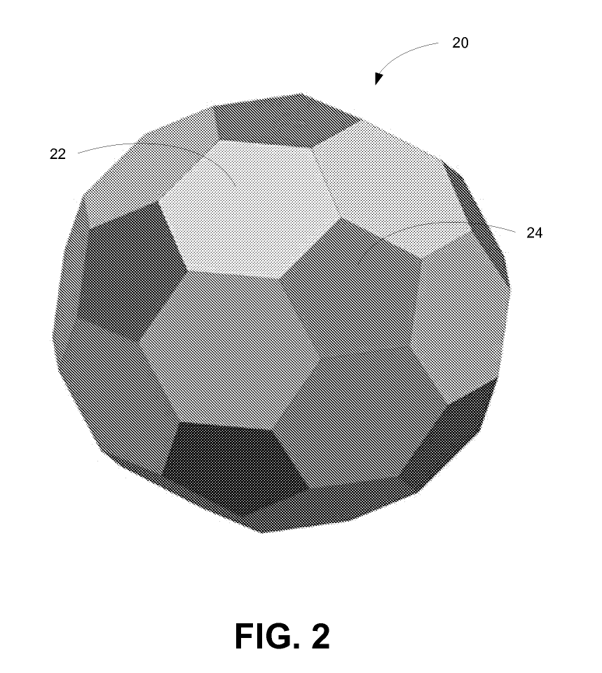

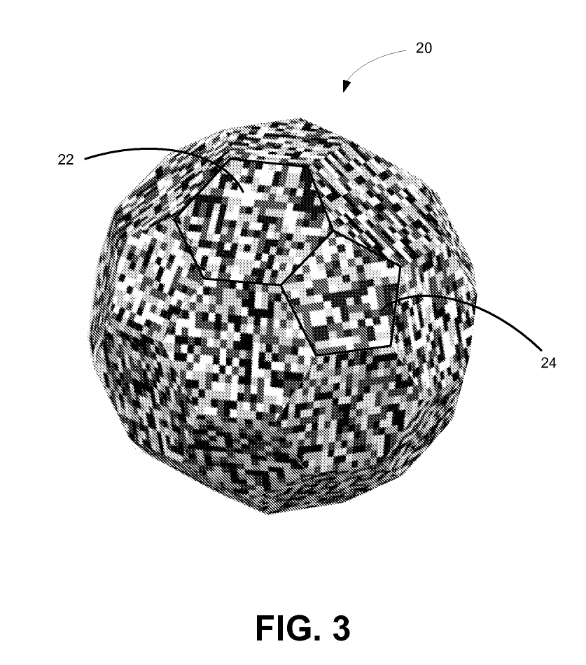

Polyhedral targeting structures of the invention may have any number of regularly or irregularly shaped facets. With reference to FIG. 1, a simple target object according to one embodiment of the invention may be a cube, with each square face comprising one or more planar targets. In more complex embodiments, the target object could have many facets with varying polygonal shapes, each facet comprising one or more planar targets. In a particular embodiment illustrated in FIG. 2, the targeting structure 20 is formed with a combination of hexagonal facets 22 and pentagonal facets 24 resulting in an appearance similar to a soccer ball. In FIG. 3, the same targeting structure 20 is shown with target patterns applied to its facets 22, 24. The target pattern for each facet is unique so that it can be associated with particular AR information relating to a pose of an image capture and display device. The pattern may be configured so that when an image of the structure 22 is captured, the particular facet closest to normal with respect to the line of view from the image capturing device can be identified and the angular deviation from the normal and the distance of the image capturing device from the targeting structure determined. This allows the determination of the exact pose of the image capturing device relative to the targeting structure without the need for an external location determination system. If the exact position and angular orientation of the targeting structure relative to a target environment (e.g., a room or compartment) is known, the pose of the image capturing device relative to the target environment can also be determined.

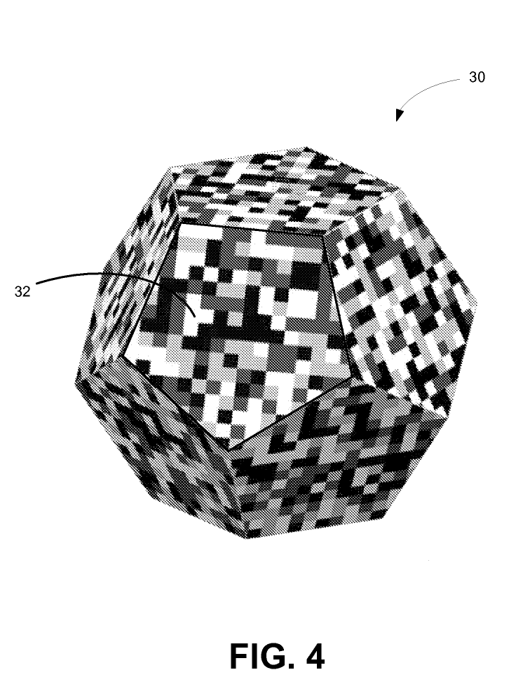

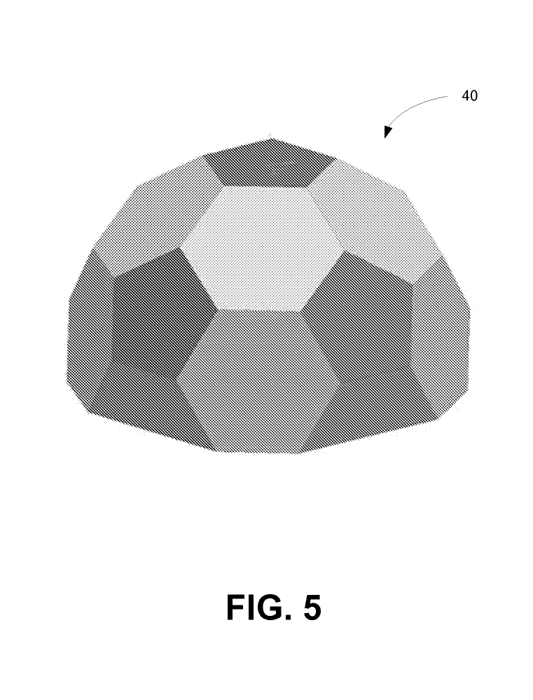

FIG. 4 illustrates another exemplary targeting structure 30, the surface of which comprises all polygonal facets 32, each having a unique target pattern applied thereto.

The targeting structures of the invention may comprise any combination of regular and irregular polygonal, planar facets. Portions of the structure may also be curved. The structures may be suspended or supported in open space so that the entire structure or a majority of the structure is viewable from any surrounding viewpoint. Alternatively, the structure may be mounted to a support surface (e.g., a wall, ceiling, or tabletop) so that target surfaces on the structure can be viewed from only one side of the support surface. In some embodiments where portions of the structure are not viewable, the structure may be configured so that only viewable surfaces or surface portions carry target patterns. FIG. 4 illustrates an exemplary targeting structure 40 that is essentially one half of the structure 20 of FIGS. 1 and 2. This embodiment could be usable in a tabletop or wall-mounted scenario in which the targeting structure will only be viewed from one side of a plane.

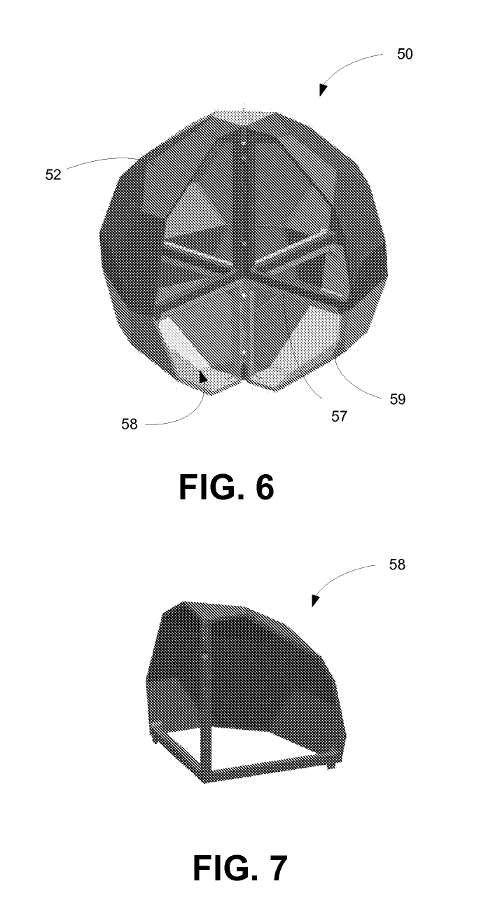

The targeting structures of the invention may be formed of any material capable of carrying a target pattern. The structures may be solid or hollow. With reference to FIGS. 6 and 7, an illustrative targeting structure 50 is formed with a shell 59 defining the outer surface comprising polygonal facets 52 and internal supports 57. The targeting structure 50 may be assembled from modular sections 58. In the illustrated embodiment in which two modular sections are omitted to permit viewing of the structure interior, the targeting structure 50 is formed from eight identical modular sections 58. Before or after assembly, unique target patterns may be applied to each facet on the external surface of the modular sections 58. The modular sections 58 may be configured with fasteners allowing easy assembly and disassembly or may be permanently fastened using mechanical fasteners or a bonding agent.

While the targeting structures of the present invention may be manufactured in various ways, a particularly suitable method is through 3-D printing. The current structure may be optimized for 3-D printing by dividing the structure into preconfigured sections that allow the structure to be printed. The unique targeting patterns may be embossed or printed directly on the corresponding targeting surface or on a separate medium in the appropriate targeting configuration, and attached to the face of each corresponding targeting surface. The sections may then be assembled into a three-dimensional configuration. The multi-targeting structure may be made from rigid materials such as plastic or metal or any material that lends itself to 3-D printing. The position of the targets relative to each other must remain stable to allow the mathematical predictability of their position. As 3-D printing technology advances, additional varieties of desired materials may be used to generate the 3-dimensional embodiments of the current invention.

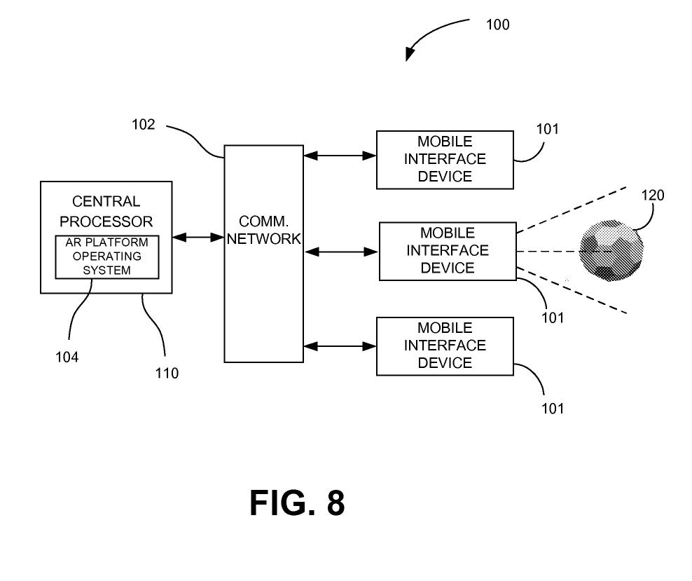

The targeting structures of the invention may be used in conjunction with systems for generating and displaying AR information similar to those disclosed in U.S. patent application Ser. No. 14/695,636, filed Apr. 24, 2015 and U.S. patent application Ser. No. 14/686,427, filed Apr. 14, 2015, the complete disclosures of which are incorporated herein by reference. A illustrative AR information display system 100 according to an embodiment of the invention is illustrated in FIG. 8. The system 100 comprises a central processor 110 in communication with one or more mobile interface devices 101 via a communication network 102. The central processor may include or be in communication with a relational database structure (not shown) as is described in U.S. patent application Ser. No. 14/210,650, filed on Mar. 14, 2014, the complete disclosure of which is incorporated herein by reference in its entirety. In general, the central processor 110 is configured to receive captured images from one or more mobile interface devices 101, identify target objects and/or surfaces in the captured images, determine the pose of the mobile interface devices 101 relative to the target objects and/or surfaces, assemble AR information associated with the identified target objects or surfaces, and send the AR information to the mobile interface devices 101 for display.

The central processor 110 may be or comprise one or more servers, data processing machines, or network-enabled computers and may host an AR operating system 104. The AR operating system 104 may be configured to control the interaction of the hardware and software components of a relational database structure (not shown). The relational database structure is configured to provide a logical framework that allows digital information to be associated with physical objects. This framework includes addresses for both tangible objects as well as individual point addresses within a coordinate system for the structural environment. In an exemplary embodiment, this coordinate system is based on a three dimensional (3D) structural model of the environment (e.g., the ship or building). Preferably, the 3D model provides a complete detail of the environment including every space, room or compartment where objects may be disposed.

In various embodiments of the invention, information processed by the central processor 110 may include asset location information from a global or local positioning system, visual or graphical information received from the mobile interface devices, observational information from users, and operational or other data from instrumentation systems associated with the environment or particular assets. Any or all of such information can be used by the central processor 110 to update object-related information and/or generate information for display via AR images that can be superimposed on the mobile device user's view of the environment or an object in the environment. The mobile interface devices used in the systems of the invention can make use of AR in a variety of ways that allow the user to conduct inspection, maintenance, repair, and replacement tasks in relation to particular assets. AR can also be used to assist a user in identifying safety hazards, locating objects, or simply navigating within the dynamic environment.

The AR operating system 104 is configured to assemble AR information for transmission to and display by the mobile device 101. The AR information is constructed using the processed environment data from the environment data systems 103 and the pose of the mobile device 101 using any of various techniques known in the art. The AR information may be presented for display as text or as graphical images that can be superimposed over real-time images captured by the mobile device 101. The AR information may be associated with specific parameters relating to the portion of the environment where the mobile device 101 is located or relating to an object or system near the mobile device 101 and/or with which the user of the mobile device 101 is interacting.

The central processor 110 may be configured or may comprise a processor or processing module and computer executable software (e.g., on a tangible computer-readable medium) configured to perform various processing functions relating to object recognition, including feature extraction to extract lines, edges, ridges, or other localized interest points from an image; detection or segmentation to select a specific set of interest points within an image or segment multiple image regions that contain a specific object of interest; image recognition to categorize a detected object into a particular category; noise reduction; contrast enhancement; and/or space scaling, for example.

The central processor 110 may be configured to receive information from one or more environment data systems (not shown) that provide information on an environment or structure within a target space. This can allow the system to change the AR information based on changes account for changes in the environment.

While the illustrative system 100 is shown with separate mobile interface devices 101 connected to a central processor by a communication network 102, it will be understood that in some embodiments, the functions of these elements may be embodied in a single device such as a data processor-equipped mobile device.

The mobile interface device 101 may be any mobile computing solution that is used by a user to facilitate communication with and display information from the central processor 110. The mobile interface device 101 may be, for example, a tablet computer, a smartphone, or a wearable heads-up display. The mobile interface device 101 may have features including, but not limited to a processor, a display (such as a screen), a vision sensor (such as a camera), a microphone, one or more speakers, and wireless communications capabilities. The mobile interface device 101 may be, in a particular embodiment, a wearable head-mounted device (HMD) such as that described in U.S. application Ser. No. 14/210,730, filed Mar. 14, 2014, the complete disclosure of which is incorporated herein by reference in its entirety. In preferred embodiments, the mobile interface device 101 is equipped or configured to display AR images/information to a user. The mobile interface device 101 may include one or more accelerometers or other motion detection sensors. Each mobile interface device 101 may include one or more unique identifiers. In some embodiments, some or all of the mobile interface devices 101 may include one or more local positioning receivers, image and object recognition, audio queues, or electromagnetic field (EMF) receivers or detectors (for GPS, WiFi, or RFID reception or light detection).

The vision sensor of the mobile interface device 101 is selected and/or configured to capture images of some or all of the surface of one or more targeting structures 120, the features of which have been previously described. The central processor and/or the relational database are configured for storage and retrieval of information on the geometry of the targeting structure, including the relative positioning of the facets of the targeting structures 120 and the unique target patterns printed thereon. One or both are also configured for storage and retrieval of information associated with each unique target pattern. In particular embodiments this information is information associated with a particular target space in which the targeting structure 120 may be located. The target space information may be selected and configured so that when its associated target pattern is identified in an captured image of the targeting structure, the target space information can be used, along with the exact relative location of the targeting structure 120, to construct AR information (e.g., an AR image) that can be displayed on the mobile device overlaid in the proper pose on the target area image.

The central processor 110 and/or mobile interface device 101 may be configured or programmed so that the target space information is permanently or semi-permanently stored, but the location of the targeting structure 120 relative to the target space can be determined and entered by a user of the mobile interface device. For example, the permanent dimensions of a room or compartment may be predetermined and stored in the system. The targeting structure 120, however, may be movable and its location within the room variable. The central processor and/or mobile interface device may be configured or programmed so that the user of the mobile interface device can enter into the system through the mobile interface device the position of the targeting structure relative to a fixed point of reference in the target room or compartment. That position may be separately measured or otherwise determined by the user. This capability allows the targeting structure to be placed anywhere in the room or compartment and still be usable by the system to provide properly posed AR images.

The central processor 110 and/or mobile interface device 101 may also be configured or programmed to store and retrieve information on the targeting structure 120 itself. In particular, the geometric relationships between the target pattern-carrying facets of the structure 120 may be stored for retrieval and use by the AR operating system 104. This allows that system to assure smooth transition in the AR information/image display as the captured images from the mobile interface device shift from one facet to another due to movement of the user.

It will be understood that various processing components of the system 100 may be combined into a single processor or further subdivided into multiple processors or servers. It will be appreciated that in some cases, multiple instances of a particular component of the system 100 may be used. Moreover, the system 100 may include other devices not depicted in FIG. 1.

Further, while the illustrative system 100 is shown with separate mobile interface devices 101 connected to a central processor by a communication network 102, it will be understood that in some embodiments, the functions of these elements may be embodied in a single device such as a data processor-equipped mobile device.

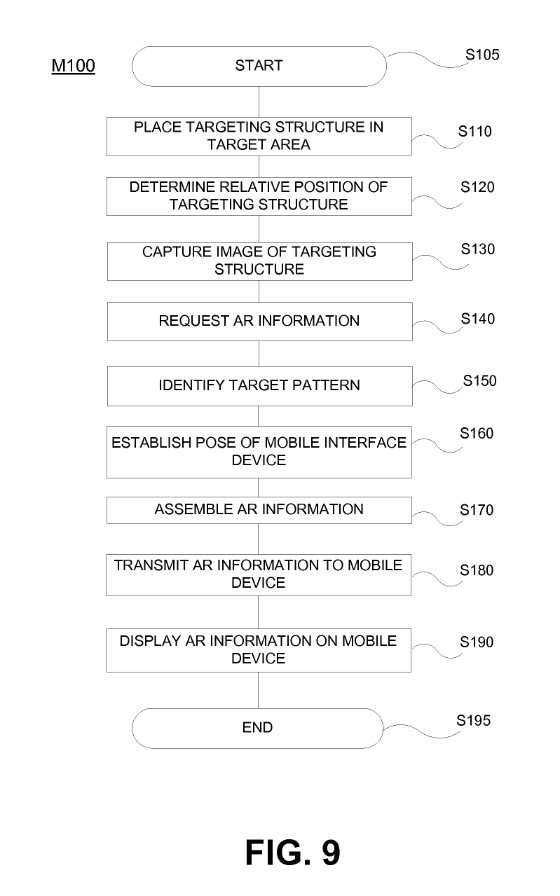

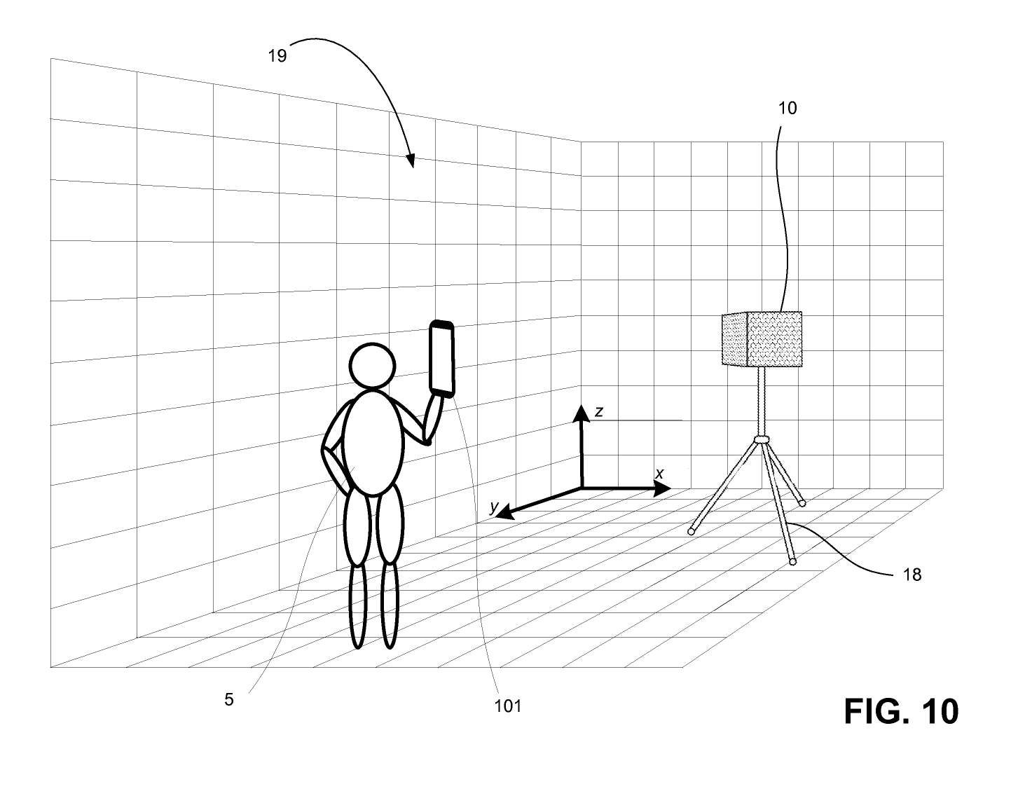

The mobile targeting structures of the invention can be used in conjunction with AR information systems such as system 100 to provide mobile device users with AR information associated with a particular space. With reference to FIG. 9, a generalized method M100 for providing AR information associated with a target space to a mobile device user begins at S105. The target space may have known dimensional parameters that can be used as a frame of reference for the user and for the AR information system. Alternatively, the target space may simply have an associated coordinate reference point as illustrated in FIG. 10. At S110, the user may place a targeting structure in a desired position within the target space. At S120, the user determines the exact location of the targeting structure relative to the reference frame of the target space. This may be done by measuring distances from fixed structures (e.g., walls, pillars, etc.) with known locations within the target space. While these measurements can be taken using any measuring device, it has been found that laser measuring tools are particularly effective. The measurements must be sufficient to locate the relative position of the targeting structure in all three dimensions. Once the user has obtained these measurements, they can be entered into the AR information system through the mobile interface device.

At S130, the mobile interface device is used to capture an image of at least a portion of the target space, the image including the targeting structure. AR information associated with the target area is requested at S140. This request may be sent by the mobile interface device to a central processor over a communication network as previously described. The captured image is then analyzed to identify the target patterns included in the image at S150. Recognition software is used by the central processor along with predetermined criteria to identify an appropriate target pattern on the targeting structure. This may be, for example, the target pattern applied to the facet of the targeting structure that is closest to normal to a line of sight from the mobile interface device to the targeting structure. The central processor and/or the mobile interface device can then, at S160, use the orientation and apparent size of the identified image, in combination with the location and geometry of the targeting structure to establish the pose of the mobile device relative to the targeting structure and the target area.

Having established the pose of the mobile interface device, the AR information system can then assemble appropriate AR information (S170) and transmit it (S180) to the mobile interface device where it is displayed to the user (S190). The method ends at S195. it will be understood that in some embodiments, all of the operations involved in providing the AR information may be carried out by the mobile interface device. In such embodiments, there is no need to transmit a request to or receive AR information from a central processor.

The AR information may include image or text information that can be superimposed over the real-time image on the mobile device. Significantly, the AR information will be positioned so that portions of the information are shown in conjunction with the associated features or equipment of the room. For example, the AR information may include an image of as-yet-uninstalled equipment positioned in the location where it is to be installed. The Ar information can also include instructions or other information to assist a the user in carrying out a maintenance or construction task with in the target space.

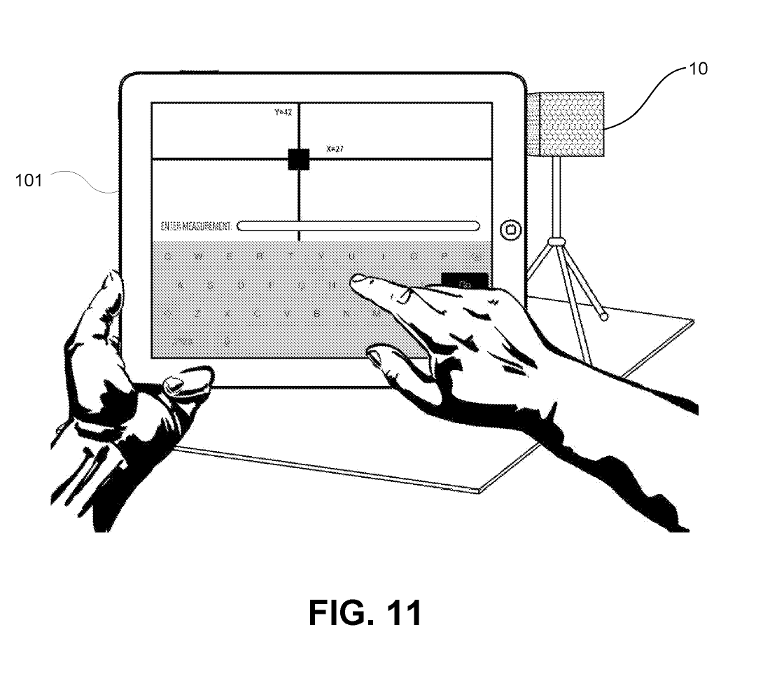

FIG. 10 presents an exemplary scenario according to the method M100. In this scenario, the user 5 has placed a cubic targeting structure 10 (similar to the structure 10 of FIG. 1) on a stand 18 within a target space 19. The exact location of the targeting structure can then be determined by measuring x, y, and z displacements from a fixed point with in the space 19. These measurements are then entered into the mobile interface device 101 as shown in FIG. 11. The user then uses a mobile interface device 101 to capture a digital image of the target area 19 including the targeting structure 10. In a particular embodiment, the measurements may be entered in conjunction with the capture of a real time image of the targeting structure within the target area. The captured image is then provided to the AR information system, which uses it along with the location of the targeting structure and previously stored information associated with the targeting structure to prepare AR information for display to the user on the mobile interface device 101.

It will be understood that, once requested, some or all of the actions of the method M100 may be repeated to periodically or continuously provide real-time environment information to the mobile interface device 101. This assures that the user is aware of variations due to changes in conditions including but not limited to: the user's location, the overall structural environment, the measured environment parameters, or combinations of the foregoing.

The methods of the invention are usable by individuals conducting virtually any operation within a dynamic or static environment. Of particular interest are uses in which real-time display of immediately recognizable cues increase the safety of a user in a potentially dangerous environment.

A potential use of the current invention is to place the targeting structure in the center of a room or space in a fixed position. The mobile interface device user may walk around the space a full 360° and/or move up and down relative to the targeting structure without losing tracking The targeting structures of the present invention also may be used in a conference type setting. In such applications, a three dimensional targeting structure may be placed at the center of a conference table allowing conference participants to visualize an augmented model. Each participant, using his own viewing device to capture an image of the target object, would be able to view the AR model in its correct pose relative to the participant's seat location at the table.

The targeting structure could also be rotated giving each participant a 360 degree view of the model. Once the scale of the targeting structure is determined and constructed for a particular model, changes in scale may be affected by changing the location of targets relative to the central point. The size of each targeting surface grows proportionately to maintain the geometric shape of the structure.

There are no known methods which provide workers with an optimized three dimensional structure that allows accurate visualization and pose from any location relative to the targeting structure without loss of pose. The ultimate geometrical shape for targeting would be a sphere that would give true unlimited targeting. This current high density, multi-planar targeting visualization methodology is possible due to the mathematical predictability of the location of every target based upon the geometrical shape used.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

What is claimed is:

1. A method for obtaining augmented reality (AR) information for display on a mobile interface device, the method comprising:
placing a three dimensional targeting structure in a target space, the targeting structure having an outer surface comprising a plurality of planar, polygonal facets, each facet having a different angular orientation and having a unique target pattern applied thereto;
determining a position of the targeting structure relative to a fixed reference point in the target space;
capturing with the mobile interface device an image of a portion of the target space including the targeting structure;
identifying the unique target pattern of a particular one of the plurality facets visible in the captured image;
establishing a pose of the mobile interface device relative to the target space using the captured image and the position of the targeting structure;
obtaining AR information from an AR operating system, the AR information being associated with the unique target pattern of the particular one of the plurality facets; and
displaying the AR information on the mobile interface device.

2. A method according to claim 1, wherein the mobile interface device is one of the set consisting of a tablet computer, a smartphone, and a wearable heads-up display.

3. A method according to claim 1 further comprising:
providing the position of the targeting structure to the AR operating system using the mobile interface.

4. A method according to claim 1, wherein the action of obtaining AR information includes:
transmitting to a central data processor from the mobile interface device over a communication network a request for AR information, the request including the captured image and the position of the targeting structure; and
receiving the AR information from the central processor over the network.

5. A method according to claim 1 wherein the actions of determining, capturing, identifying, establishing, obtaining, and displaying are periodically repeated.

6. A method according to claim 1 wherein the AR operating system has access to previously stored geometry information for the targeting structure.

7. A method according to claim 6 wherein the stored geometry information includes spatial relationships between the facets of the targeting structure.
